(19) United States
(12) Patent Application Publication
(10) Pub. No.: US 2013/0114239 A1
(43) Pub. Date: May 9, 2013

(54) SOLAR SIMULATOR FILTER COLLIMATOR

(71) Applicant: SPIRE CORPORATION, Bedford, MA (US)

(72) Inventors: Harvey B. Serreze, Pepperell, MA (US); Jason E. Burns, Cambridge, MA (US)

(73) Assignee: SPIRE CORPORATION, Bedford, MA (US)

(21) Appl. No.: 13/682,001

(22) Filed: Nov. 20, 2012

Related U.S. Application Data
(63) Continuation-in-part of application No. 13/373,176, filed on Nov. 7, 2011.

(51) Int. Cl. F21V 9/02

(52) U.S. Cl. CPC F21V 9/02
USPC 362/2

(57) ABSTRACT

A solar simulator includes a source producing radiation and filter material for the source having a higher transmittance at predetermined wavelengths for radiation incident at non-normal angles to the filter material. A collimator between the source and the filter material absorbs a fraction of the non-normal incident radiation to lower the amount of radiation at the predetermined wavelengths reaching the filter material. In one example, the collimator is a metallic honeycomb substrate. The collimator may also include baffles.

### RELATED APPLICATIONS

This application is a continuation-in-part of U.S. patent application Ser. No. 13/373,176 filed Nov. 7, 2011 and claims the benefit of and priority thereto under 35 U.S.C. §§119, 120, 363, 365, and 37 C.F.R. §1.55 and §1.78 and is incorporated herein by this reference.

### FIELD OF THE INVENTION

The subject invention relates to photovoltaics and, more particularly, solar simulators.

### BACKGROUND OF THE INVENTION

Solar simulators are used for testing photovoltaic modules. One requirement of a solar simulator is that it must produce an optical output spectrum that closely matches that of natural sunlight. Standards defining an acceptable spectral output for solar simulators have been developed by both ASTM International and the IEC. Such standards specify the fractions of total optical power in each of 6 100 nm or 200 nm wide wavelength intervals (or bins) from 400 to 1,100 nm. To achieve class A spectral performance, the output of the simulator must be within +/−25% of the mean values specified in the standard.

The most commonly used light source in pulsed solar simulators is a low pressure Xenon arc lamp. Although such a lamp possesses adequate short wavelength output (less than 500 nm), it emits excessive near-infrared (greater than 700 nm) radiation.

To compensate for this excess radiation, optical filters (often arranged in an array configuration with large-area simulators) can be used to attenuate the output in the near infrared. The two most important features of the filter design are its cutoff wavelength (the wavelength at which the transmittance equals 50%) and the average transmittance in the long wavelength region (900 to 1.100 nm). The cutoff wavelength primarily affects the simulator output in the 700 to 800 and 800 to 900 nm bins, while the long wavelength transmittance mostly affects the output in the 900 to 1,100 nm bin.

It can be very difficult to control these two filter parameters independently. Typical filters are typically made using a multitude of dielectric layers each of a thickness less than the optical wavelength. Design changes made to affect the cutoff characteristics may not yield the most desirable long wavelength properties. Conversely, tailoring the long wavelength properties may adversely affect the cutoff characteristics and, in some cases, even reduce the transmittance at the shortest wavelength region (less than 450 nm) which needs to remain high to give adequate near ultraviolet (400 to 500 nm) output. The difficulty of controlling these filter characteristics is manifested in an output spectrum resulting from such prior art filters which are not class A by virtue of a slightly too high or too low output in the 800 to 900 nm and 900 to 1,100 nm bins.

Sometimes, a given filter will block too much radiation at wavelengths between about 900 to 1,100 nm. In the Assignee's U.S. Pat. No. 8,052,291, incorporated herein by this reference, small areas of the dielectric material layer stacks of a filter were etched away or otherwise removed sufficiently increasing the effective transmittance between about 900 and 1,100 nm in order to achieve class A performance

### BRIEF SUMMARY OF THE INVENTION

In some cases, due to normal manufacturing variations, a given filter, even of the same type from the same manufacturer, will effectively transmit too much radiation at wavelengths from about 800 to 1,100 nm to achieve class A performance. One contribution to excessive transmission from 800-1100 nm is a shift in filter properties that occurs when non-normal radiation is incident on the filter surface. This shift allows a larger fraction of NIR transmission for non-normal incidence which raises the total fraction of radiation for that bin. The inventive solution is a collimator placed near or adjacent to the filter material and configured to reflect and absorb a fraction of the non-normal incident radiation to lower the amount of radiation at certain wavelengths impinging on or passing through the filter.

Featured is a solar simulator comprising a source producing radiation and filter material for the source having a higher transmittance at predetermined wavelengths for radiation incident at non-normal angles to the filter material. A collimator between the source and the test plane is configured to absorb a fraction of the non-normal incident or filtered radiation to lower the amount of radiation at the predetermined wavelengths reaching or passing through the filter material. In one example, the collimator is a metallic honeycomb substrate. The collimator may also include baffles.

Preferably the source is a Xenon arc lamp. The predetermined wavelengths of interest are typically between about 800 and 1,100 and possibly up to 1,300 nm. Further included may be a source fixture with a chamber for the source and one or more walls including the filter material. One wall may include the collimator thereon. A cover for the chamber may include a diffusing surface facing the source. There may be a collimator between the cover and the source. The fixture may further include blocking portions such as mirrors positioned to address longitudinal non-uniform intensities of the source.

The simulator may further include surfaces about the source fixture for diffusing radiation emitted by the source and specular reflectors positioned to steer diffused radiation to a target surface and oriented to create a uniform intensity distribution across the target surface. The diffusing surfaces may include a diffusing outwardly angled wall on each side of the source fixture positioned to reflect radiation towards the target surface.

Also featured is a solar simulator comprising a source, a filter for the source, and a collimator between the source and the filter configured to absorb a fraction of non-normal incident radiation directed to the filter material.

A solar simulator source fixture in accordance with examples of the invention preferably include a source and a chamber for the source covered by a diffusing surface. The fixture sidewalls and a floor include filter material. A collimator is disposed inside the fixture over at least a portion of the filter material and is configured to absorb a fraction of non-normal incident radiation produced by the source directed at the filter material. In one example the collimator is disposed on the floor and includes a metallic honeycomb substrate.

The invention also features a method comprising producing radiation at predetermined wavelengths, filtering the radiation using filter material having a higher transmittance at predetermined wavelengths for radiation incident at non-normal angles to the filter material, and absorbing a fraction of the non-normal incident radiation to lower the amount of radiation at the predetermined wavelengths. Absorbing may include placing a collimator between the filter material and a source producing the radiation. The method may further include blocking the radiation at predetermined locations to produce more uniform intensities, diffusing the radiation, and/or steering diffused radiation to produce more uniform intensities.

One method includes placing a source in a chamber, covering the chamber with a diffusing surface, using filter material to form sidewalls and a floor for the chamber, and placing a collimator inside the fixture for at least a portion of the filter material for absorbing a fraction of non-normal incident radiation produced by the source and directed at the filter material. The collimator may be a honeycomb structure. The method may further include adding mirrors to the chamber to block radiation for the source at certain locations to produce more uniform intensities.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three dimensional schematic end view of an example of a new solar simulator in accordance with the invention with one end panel removed showing the primary structures associated with the new simulator;

FIG. 2 is a schematic three dimensional top view showing one example of a source fixture in accordance with the invention; and

FIG. 3 is a graph showing transmittance versus wavelength for the filter material used in the solar simulator of FIG. 1 and the source housing of FIG. 2 for different incident angles;

FIG. 4 is a conceptual cross sectional view showing an embodiment of a solar simulator in accordance with the subject invention;

FIG. 5 is a highly schematic view showing the primary components of the fixture of FIG. 2;

FIG. 6 is a graph showing fractional amount of irradiance as a function of wavelength comparing designs without a collimator and a design with a collimator in accordance with the subject invention; and

FIG. 7 is a cross sectional end view of another simulator including aspects of the invention.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

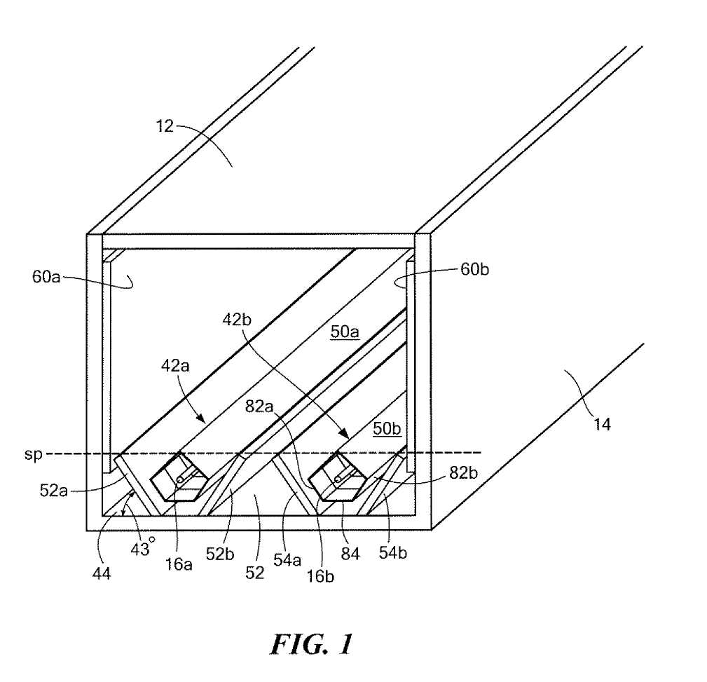

In one preferred embodiment, a solar simulator, FIG. 1 includes target surface 12 and enclosure 14 with source fixtures 42a and 42b therein typically spaced close to floor 44 and a half a meter or so from target surface 12. Within each source fixture is a lamp 16a, 16b, typically a 2 meter long xenon tube.

There are diffusing surfaces about fixtures 42a and 42b for diffusing radiation emitted by lamps 16a and 16b. Preferably, the fixtures define a source plane SP as shown in FIG. 1 and all reflecting surfaces behind it typically are diffusing. Examples include covers 50a and 50b for the fixtures (painted white inside and out), floor surface 52, and outwardly angled walls 52a and 52b on opposite sides of and coextensive with fixture 42a along with outwardly angled walls 54a and 54b on opposite sides of and coextensive with fixture 42b. These angled walls are positioned and oriented to reflect lamp radiation towards surface 12.

One preferred system also includes specular reflectors positioned to steer the diffused radiation to target surface 12 and oriented to create a uniform intensity distribution across target surface 12. Preferably, these specular reflectors are between the source plane SP and target surface 12. In the example discussed so far, mirrors 60a and 60b, FIG. 1 are provided above diffusing walls 52a, 52b, 54a, 54b and inside and closely adjacent to or on the side walls of the enclosure and other mirrors are provided inside and adjacent to or on the end walls of the enclosure.

The mirrors can be adjusted and angled via various mounts, for example, with respect to the walls to adjust the intensity distribution of the radiation striking the target surface. Mirror mounting options like a tilt mirror may be used. Also, the angles of the diffusing walls (52, 54) and their position relative to each other and the fixtures can also be adjusted to tune the intensity distribution of radiation striking target surface 12. Typical angles for the mirrors are +/−5° from vertical. Diffusing walls 52, 54 are typically oriented at 43° from horizontal. Since the walls 52, 54 are typically coextensive with lamp 16, the walls are typically approximately 2 meters long. For simulator enclosures of different sizes, these dimensions may vary.

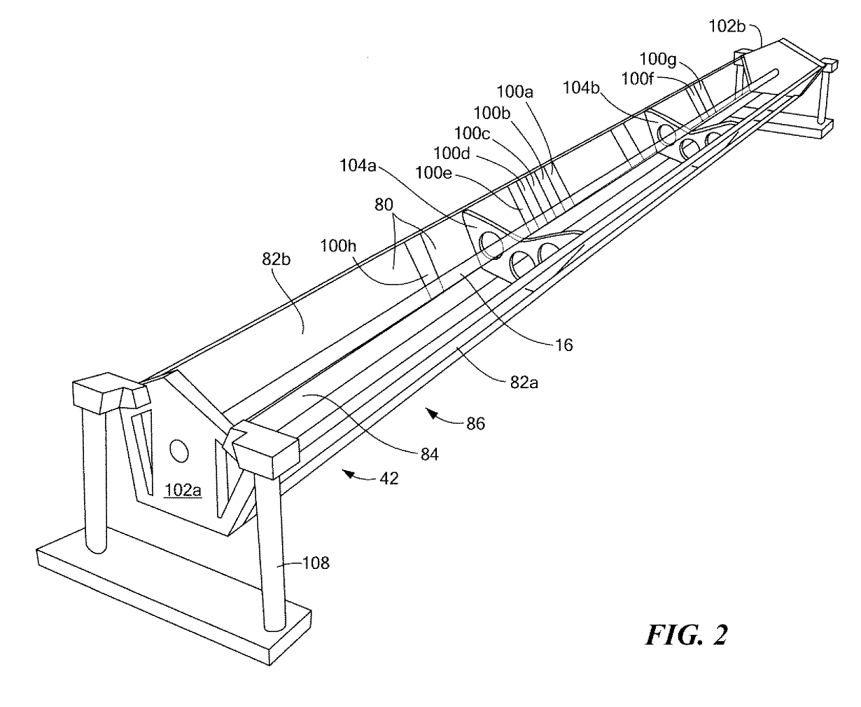

In one design, each source fixture 42, FIG. 2 (there may be only one source fixture in smaller simulators) includes filter material plates making up the majority of side walls 82a, 82b and floor 84 of chamber 86 surrounding lamp 16. Cover 50, FIG. 1 includes diffusing surfaces facing lamp 16 and typically outside diffusing (white) surfaces as well. By placing the infrared filters (and/or any other desired filters) closely adjacent lamp 16, less filters compared to previous full-filter area designs are required. A collimator is also typically included as discussed below.

The filter material may be hot mirror filters typically including a stack of layers of alternating dielectric material (such as, but not limited to SiO₂, TiO₂, Ta₂0₅, and the like) deposited upon a transparent substrate such as glass. Each layer is typically less than one optical wavelength in thickness and the total number of layers is generally between 10 and 50. The filters are typically in the form of small plates and may be used to form the fixture walls and floors as shown in FIGS. 1 and 2.

A large fraction of light rays passing from the source 16 through the filters are far from normal. The resulting mix of incident ray angles can render proper filter design extremely difficult and can also place a heavy burden on the filter manufacturer's ability to accurately control and reproduce the desired filter characteristics during repeated manufacturing deposition cycles. In addition, if a change in effective filtered transmittance is desired in order to modify the simulator spectrum, both the cost for a different filter set and the time needed to produce it can be prohibitive.

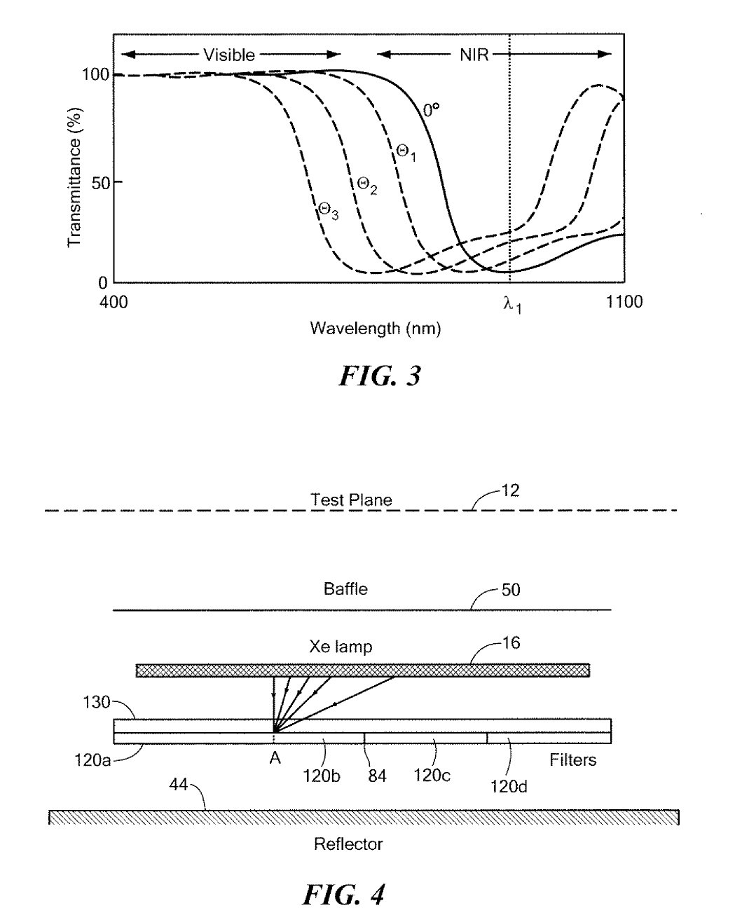

The angle of incidence of the rays from the source can vary all the way from normal to glancing angles approaching 90°. Consequently, the effective transmittance of the filter in the near infrared wavelengths will vary considerably from its normal incidence value as demonstrated by the plurality of increasing transmittance values at wavelength λ₁ shown in FIG. 3 for incidence angles θ1, θ2, and θ3. The filters have a higher transmittance at predetermined wavelengths such as those above λ₁ for radiation incident at non-normal angles to the filter. Accordingly, a collimator is preferably associated with fixture 42, FIG. 2.

By controlling the amount of light impinging upon the filters at off-normal incidence angles using a collimator, transmittance of wavelength greater than λ₁ can be dramatically reduced. In FIG. 3, the net effective transmittance to a point in a filter plate would decrease from the sum of all the individual transmittances at the near infrared λ₁ to the weighted sum of only those less than a critical acceptance angle of the collimator. This results in a significant decrease of near infrared radiation emitted by the simulator compared to the situation where no collimation employed.

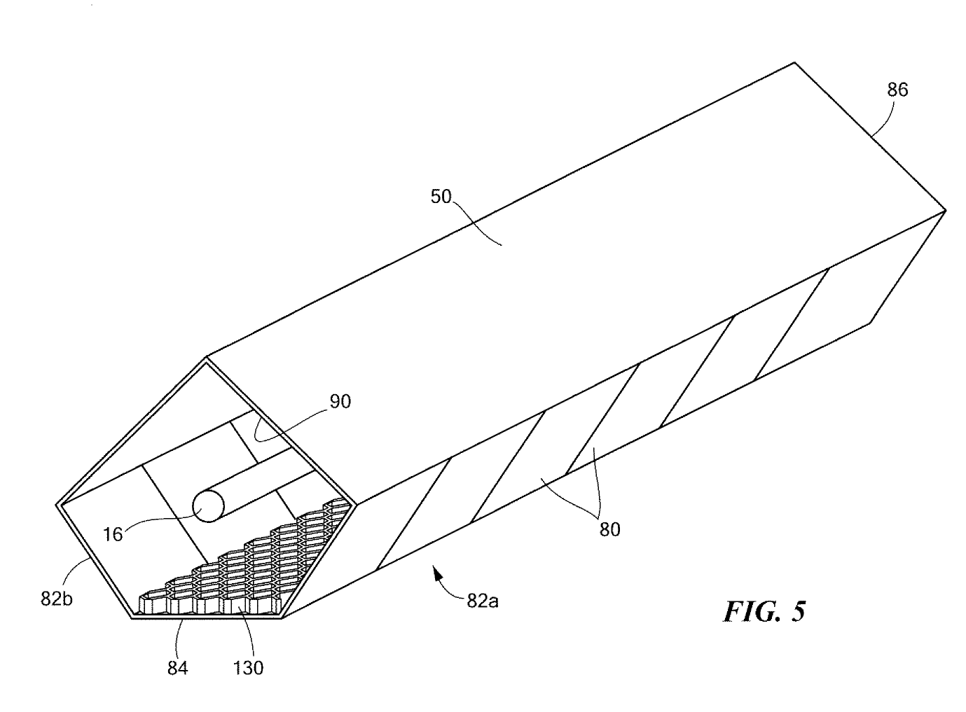

FIG. 4 shows Xenon source lamp 16 under baffle 50 and above filter plates 120a, 120b, 120c, and 120d of the floor of the fixture shown in FIG. 2 but now also the addition of collimator 130 between the source 16 and the filter material configured to reflect and absorb a fraction of the non-normal incident radiation to lower the amount of radiation at the predetermined wavelengths discussed above (typically between about 800 to 1,100 nm). FIG. 5 shows an example where the collimator 130 is a metallic honeycomb substrate placed on floor 84 made of individual plates of the filter material.

The honeycomb material is typically constructed using thin polished or specular aluminum foil which is available commercially. Light rays whose angle from normal is less than a critical angle will pass through unobstructed. However, those light rays at an angle greater than critical angle will be reflected or absorbed by the collimator honeycomb walls. Accordingly, a fraction of the non-normal incident radiation is absorbed. The height to width ratio of each honeycomb cell is preferably between about 0.3 and about 3. In one example, honeycomb cells ⅜″ tall and ½″ wide were used. A collimator could also include baffles placed normal to the longitudinal axis of the Xenon lamp. The amount of collimation is controlled by the height, spacing, and location of the baffles to absorb the appropriate fraction of the non-normal incidence radiation in order to lower the amount of near infrared radiation passing through the filters. The material of the collimators can vary as can the nature of the side walls which can be of various colors, and surface roughness. The amount of collimation can be adjusted by varying such parameters as the coverage fraction (i.e., the fraction of filter area that has a collimator over it) and the height to width ratio. Accordingly, collimators could be placed on floor 84, FIG. 5, side walls 82a and/or 82b, and the like. In one example, honeycomb collimator 130 was co-extensive with fixture floor 84. Additionally, collimators may be placed on the baffle 50 reducing the non-normal incident radiation reflected back to the filters 120a-d.

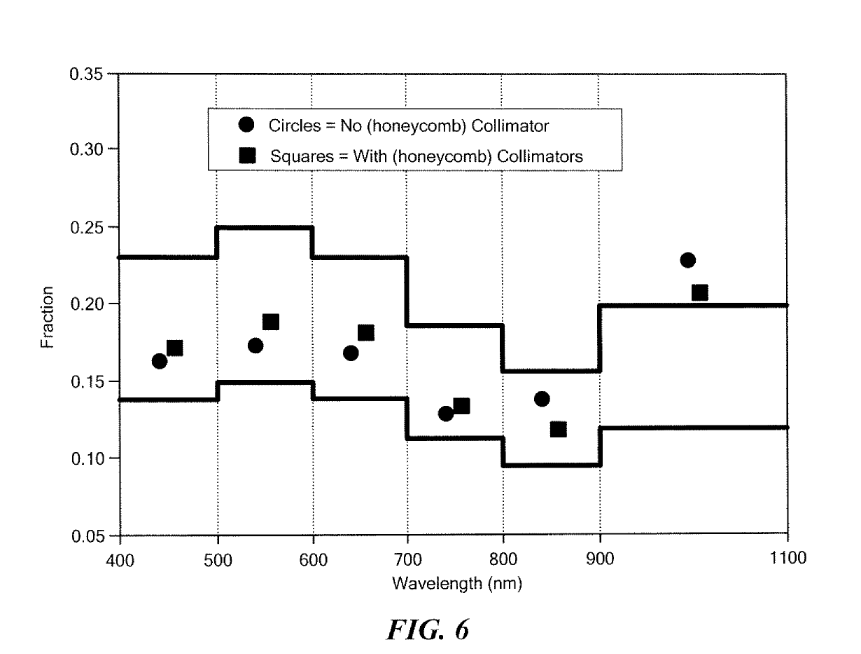

FIG. 6 depicts the fractional amount of irradiance in six 100 or 200 nm wide intervals or bins from 400 to 1,100 nm for a simulator without and with honeycomb type collimators as depicted in FIG. 5. The heavy lines denote the upper and lower limits of a class A spectrum as defined by standards IEC 60904-9 and ASTM E927-10. It is apparent that the relative fractions of irradiance in the two longest wavelength near infrared bins (800-900 nm and 900-1,100 nm) decreased significantly upon insertion of the honeycomb collimator.

Other features include five mirrors 100a-100e, FIG. 2 placed on side wall 82b in this specific example near its middle, two mirrors 100f and 100g placed as shown to the right and one mirror 100h placed as shown to the left to address longitudinal non-uniform intensities of lamp 16. Each mirror has a reflective inner surface and a diffusing outer surface. The number, size, and position of the mirrors or other blocking elements will depend on the type and design of lamp 16. The blocking portions may be diffuse on both sides. Other components of the source fixture also shown in FIG. 2 include end walls 102a and 102b, spacers 104a, 104b, and support structure 108.

It is preferred to use diffusing rather than specular optics behind the source plane SP. FIG. 1 and also preferred to use specular rather than diffusing optics between the source plane and the target plane. Blocking or obscuring elements or baffles are typically not needed and obscuring elements such as a mask between the source plane and the target are minimized or eliminated. The clustering of the spectrum altering elements or filters close to the lamp reduces the quantity of these expensive elements and their total surface area.

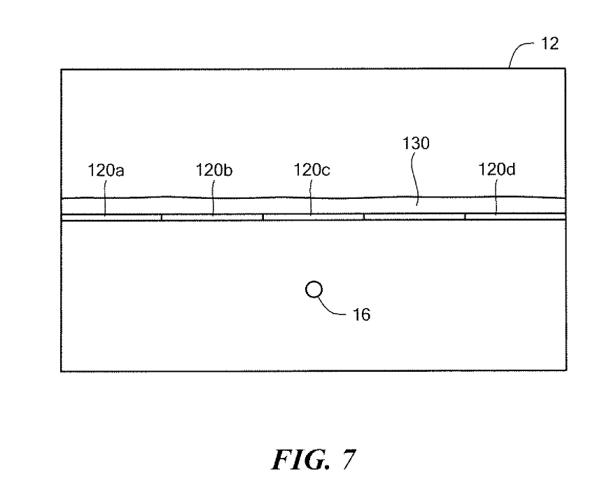

In the version of FIG. 7, the simulator chamber 12 includes diffuse reflective surfaces about Xe lamp 16. See U.S. Pat. No. 8,052,291. Filters 120 are in the optical path between lamp 16 and transparent output surface or test plane 12. Honeycomb or other collimator material 130 is placed on top of filters 120 and absorbs filtered radiation to the same effect as shown in FIG. 6.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents. Many equivalents will be unforeseeable at the time of the amendment and are beyond a fair interpretation of what is to be surrendered (if anything). The rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. A solar simulator comprising:
a test plane;
a source producing radiation;
filter material between the test plane and the source having a higher transmittance at predetermined wavelengths for radiation incident at non-normal angles to the filter material; and
a collimator between the source and the test plane configured to absorb a fraction of the non-normal incident or filtered radiation to lower the amount of radiation at said predetermined wavelengths.

2. The simulator of claim 1 in which the collimator is a metallic honeycomb substrate.

3. The simulator of claim 1 in which the collimator includes baffles.

4. The simulator of claim 1 in which the source is a Xenon arc lamp.

5. The simulator of claim 1 in which the predetermined wavelengths are between about 800 and 1,300 nm.

6. The simulator of claim 1 further including a source fixture with a chamber for the source and one or more walls including said filter material.

7. The simulator of claim 6 in which one said wall includes the collimator thereon.

8. The simulator of claim 6 further including a cover for the chamber including a diffusing surface facing the source.

9. The simulator of claim 8 further including a collimator between the source and the cover.

10. The simulator of claim 1 in which the collimator is between the filter material and the test plane.

11. The simulator of claim 6 further including surfaces about the source fixture for diffusing radiation emitted by the source and specular reflectors positioned to steer diffused radiation to a target surface and oriented to create a uniform intensity distribution across the target surface.

12. The simulator of claim 11 in which the diffusing surfaces include a diffusing outwardly angled wall on each side of the source fixture positioned to reflect radiation towards the target surface.

13. A solar simulator comprising:
a test plane;
a source;
a filter for the source; and
a collimator between the source and the test plane configured to absorb a fraction of non-normal incident or filtered radiation.

14. A solar simulator source fixture comprising:
a source;
a chamber for the source covered by a diffusing surface;
sidewalls and a floor including filter material for the source; and
a collimator inside the fixture for at least a portion of the filter material configured to absorb a fraction of non-normal incident radiation produced by the source directed at the filter material.

15. The source fixture of claim 14 in which the collimator is disposed on the floor and/or between the source and the diffusing surface.

16. The source fixture of claim 14 in which the collimator is a metallic honeycomb substrate.

17. The source fixture of claim 14 in which the collimator includes baffles.

18. The source fixture of claim 14 in which the source is a Xenon arc lamp.

19. The source fixture of claim 14 further including blocking portions positioned to address longitudinal non-uniform intensities of the source.

20. The source fixture of claim 19 in which said blocking portions include elements mirrored on the inside and diffuse on the outside or diffuse on both sides.

21. A method comprising:
producing radiation at predetermined wavelengths;
filtering said radiation using filter material having a higher transmittance at predetermined wavelengths for radiation incident at non-normal angles to the filter material; and
absorbing a fraction of the non-normal radiation to lower the amount of radiation at said predetermined wavelengths.

22. The method of claim 21 in which absorbing includes placing a collimator between the filter material and a source producing the radiation.

23. The method of claim 21 in which absorbing includes placing a collimator between the filter material and a test plane.

24. The method of claim 21 further including diffusing said radiation.

25. The method of claim 24 further including steering diffused radiation to produce more uniform intensities.

26. A method comprising:
placing a source in a chamber;
covering the chamber with a diffusing surface;
using filter material to form sidewalls and a floor for the chamber; and
placing a collimator inside the fixture for at least a portion of the filter material for absorbing a fraction of non-normal incident radiation produced by the source and directed at the filter material.

27. The method of claim 26 in which the collimator is a honeycomb structure.

28. The method of claim 26 further including adding minors to the chamber to block radiation from the source at certain locations to produce more uniform intensities.
